(19) United States
(12) Patent Application Publication
(10) Pub. No.: US 2010/0242814 A1
(43) Pub. Date: Sep. 30, 2010

(54) HIGH TEMPERATURE FURNACE WITH AN OXYGEN-FREE INFEED SECTION AND USE OF SUCH A FURNACE

(76) Inventor: Peter Jeney, Zug (CH)

Correspondence Address: MCCORMICK, PAULDING & HUBER LLP, CITY PLACE II, 185 ASYLUM STREET, HARTFORD, CT, 06103, US

(21) Appl. No.: 12/740,858

(22) PCT Filed: Aug. 9, 2007
(86) PCT No.: PCT/EP07/58264

§ 371 Date: Apr. 30, 2010

(30) Foreign Application Priority Data
Jul. 13, 2007 (EP) PCT/EP2007/057265

(51) Int. Cl. F23K 3/00; H05B 6/02

(52) U.S. Cl. 110/341; 373/138

(57) ABSTRACT

High-temperature furnace (10) for processing carbon-containing material in an inner zone (8) at a high-temperature. The furnace (10) comprises an in-feed side (20) for continuously feeding said carbon-containing material into said inner zone (8) and an output side (30) where a Syngas is provided. The infeed side (20) comprises an infeed section (23) providing for an atmosphere being essentially oxygen-free. There is gas inlet (22.1) at the infeed section (23) which is connected to the output side (30) for feeding some of said Syngas into said infeed section (23).

The priority of the following co-pending patent application is claimed: PCT/EP2007/057265, as filed on 13 Jul. 2007.

The invention relates to high-temperature furnaces and in particular to induction furnaces which are particularly suitable for the disposal or processing of waste materials and/or biomass by continuous high temperature degradation, although they may be used in other applications, such as for example roasting of ores and minerals. The invention specifically relates to high-temperature furnaces having a special infeed section for continuously feeding material into said furnace.

Electrically powered furnaces in which heat is produced by electrical induction are well-known. The basic structure of such furnaces comprises an electrical coil within which is placed a susceptor.

An example of an inductive furnace is disclosed in the European patent EP 1495276 B1.

The passage of alternating electrical current through the coil produces heat in the susceptor which is used to heat the furnace. A preferred material for the susceptor theoretically would be graphite. In practical applications, like the present invention metals and in particular noble metals, are used. However, particularly at high temperatures, unprotected susceptors, no matter what materials are being used, are attacked by oxygen and thereby eroded and/or oxidized in use and therefore are unsuitable for use in a furnace for prolonged use at high temperatures unless oxygen is totally excluded from the furnace.

Attempts have been made to solve the problems caused by oxygen in the furnace, but it turned out that some of the carbon-containing materials which are typically processed by such furnaces do carry a certain amount of oxygen in itself. If this oxygen is released in the furnace, the walls or chamber may be destroyed.

The problem of oxygen attack may also be observed at the walls or chamber of other directly or indirectly heated furnaces or reactors, such as annealing furnaces or combustion furnaces which reach fairly high temperatures.

The present invention seeks to provide a furnace where no oxygen is able to enter the inner zone.

The present invention accordingly provides a susceptor, reactor or furnace wall or furnace chamber for processing carbon-containing material in a respective inner zone at a high-temperature where an atmosphere is provided which is essentially oxygen-free. The respective device comprises an infeed side, for continuously feeding the carbon-containing material into the inner zone, and an output side where a so-called Syngas is provided. The infeed side comprises an in-feed section providing for an oxygen-free atmosphere. According to the present invention, the infeed section comprises a gas inlet being connectable to the output side in order to be able to feed some of said Syngas back into said infeed section.

In a preferred embodiment, the present invention provides a susceptor, reactor or furnace wall or furnace chamber wherein a protective structure is provided which comprises a molybdenum compound, respectively a molybdenum-based susceptor (e.g. a susceptor comprising a molybdenum alloy), and a Silicon-Boron (SiB) compound coating, respectively a Silicon-Boron-based coating layer. This protective structure prevents any oxygen damages inside the furnace if, despite the Syngas feedback, oxygen was able to enter the inner zone.

The present invention further provides the use of a susceptor, reactor or furnace with a Syngas feedback in the high-temperature treatment of waste materials, plants, wood, or high-temperature roasting of ores and minerals.

The advantage of the Syngas feedback is that the Hydrogen of the Syngas will react with oxygen that is contained in the material which is to be processed in the furnace. Due to this reaction, the oxygen will be removed from the material before it enters the inner zone of the furnace.

It is another advantage of the Syngas feedback that the elevated temperature of the Syngas provides for a pre-heating of the material at the infeed side of the furnace.

The furnace presented herein can be used for the continuous processing of all sorts of carbon-containing materials, even if these materials should be chemically aggressive materials.

The susceptor, reactor or furnace will preferably be arranged to operate at a slight angle to the horizontal so that material fed through the furnace at its upper end is assisted by gravity to move to the lower end. To further assist the progress of the material, means are provided to rotate the susceptor, reactor or furnace about its main axis. Furthermore, the inner surface of the susceptor, reactor or furnace is preferably formed with one or more protrusions to assist progress of the material which is being heated, such protrusion or protrusions being preferably in the form of one or more helical flanges.

Regarding the use of refractory materials in the furnace, it will be appreciated that the whole of the revolving part of the furnace should be very adequately supported in order to prevent undue stresses in the refractory material. This is important since any undue stress may also affect the coating material.

The reactor or furnace is designed to be operated at elevated temperatures between 800° C. and 1700° C., preferably above 1250° C.

One possible furnace, e.g. an induction furnace, of the invention will now be illustrated by way of example with reference to the accompanying drawing in which:

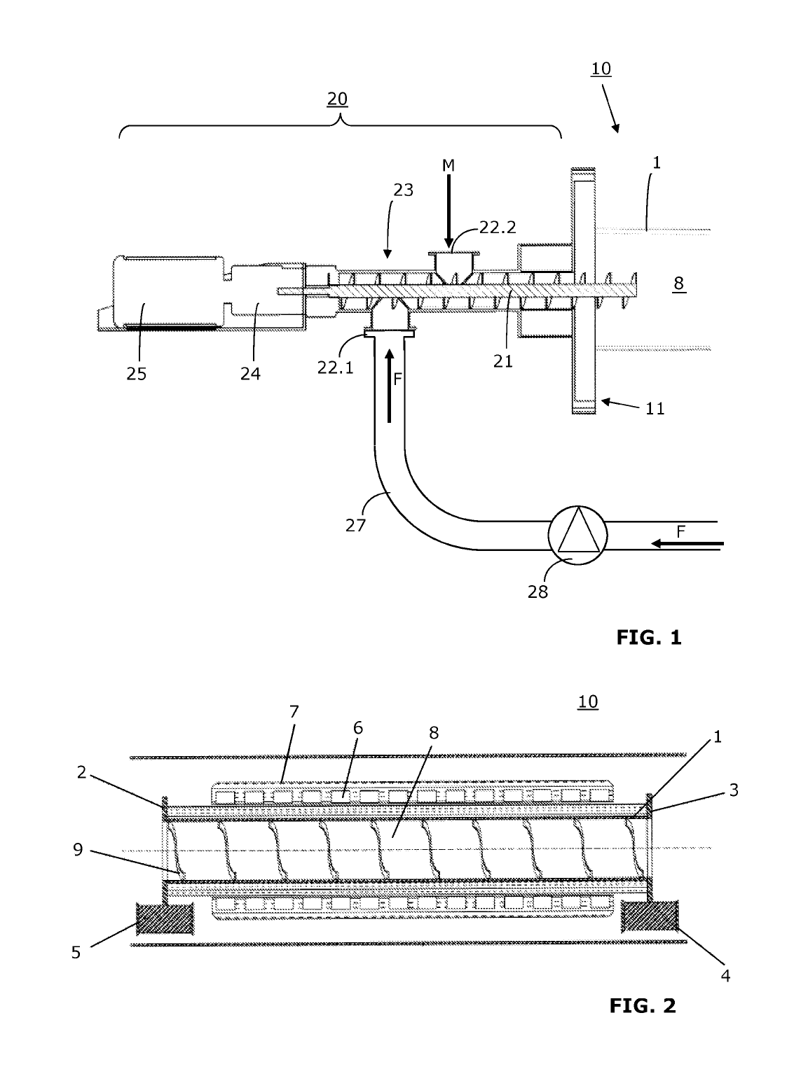

FIG. 1 is a vertical section of the infeed side of an induction furnace in accord with the present invention;

FIG. 2 is a vertical section of the main part of an induction furnace in accord with the present invention;

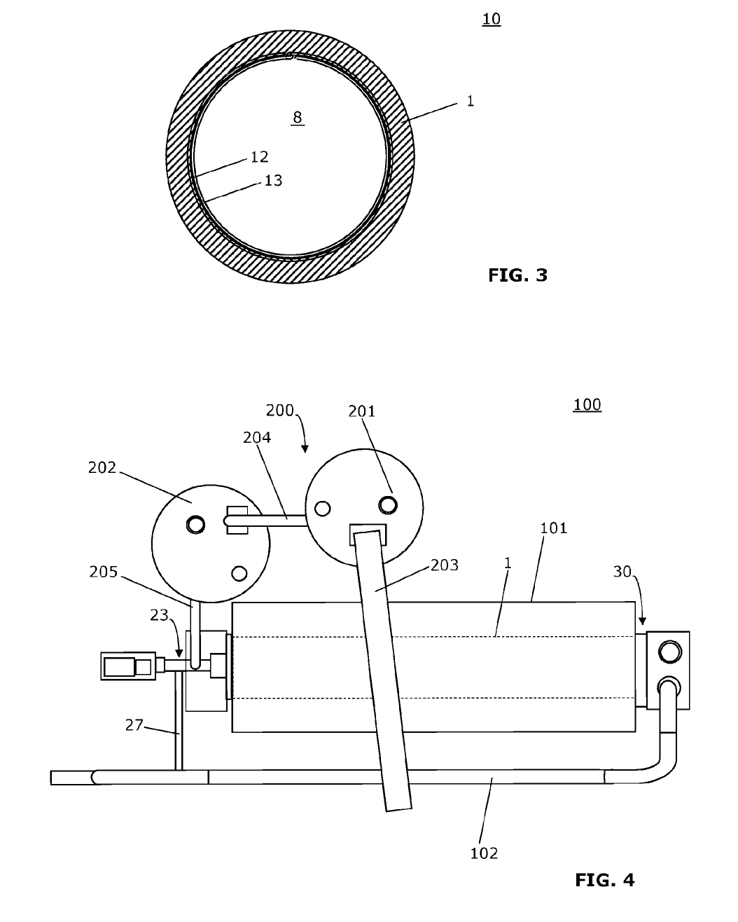

FIG. 3 is a cross-section of an inventive furnace;

FIG. 4 is a schematic top view of a furnace with several of the peripheral systems.

### DETAILED DESCRIPTION

The present invention concerns high-temperature susceptors, reactors, furnaces and ovens. For the sake of simplicity, in the following, the word furnace is used as synonym for all the different kinds of high-temperature systems where the invention can be advantageously employed.

When referring to “high-temperatures” or “elevated temperatures”, temperatures above 800° C. and preferably above 1000° C. are meant. In some applications, the temperature can reach 1700° C.

The input (infeed) side of a furnace 10 is shown in FIG. 1. The furnace itself comprises a cylinder 1 of a refractory material, e.g. a refractory alloy, having a length of approximately several meters (e.g. between 1 and 8 meters), an internal diameter of approximately 0.1-0.5 meters and an external diameter of approximately 0.12-0.52 meters, for instance. The cylinder 1 of the furnace 10 may be rotated about its horizontal axis by means of a spur gear 11.

The infeed side 20 comprises an infeed section 23 which is designed to provide for an oxygen-free atmosphere. According to the present invention, the infeed section 23 comprises a gas inlet 22.1 being connectable to an output side 30 of the furnace 10. This arrangement enables the feed back of some of the Syngas (also called synthesis gas; a gas comprising carbon monoxide (CO) and hydrogen (H₂)) into said infeed section 23.

As illustrated in FIG. 1, a feedback pipe 27 may be provided which connects the output side 30 of the furnace 10 with the infeed section 23. The flow of the Syngas inside the feedback pipe 27 is illustrated by two arrows F.

The carbon-containing material which is to be processed in the furnace 10 is conveyed by means of a conveyor or worm 21 (e.g. an auger feeder) from the left hand side of FIG. 1 to the right hand side. An engine 25 and a gear box 24 may be employed to rotate worm 21 or move the conveyor. As illustrated in FIG. 4, there are two connected containers 201 and 202 which contain the material to be processed. These two containers 201, 202 are sealed so that no or almost no oxygen is contained in these containers. Special gating means can be provided in order to provide for the necessary sealing. Conveyors (e.g. auger elevators) 203, 204, and 205 can be employed to move the material to be processed.

As illustrated in FIG. 1, the material may drop from above (see arrow M) through an inlet port 22.2 onto the conveyor 21 situated in said infeed section 23.

Well suited is a feed-system 200 with a series of containers 201, 202 and conveyors 203, 204, 205 operated with a nitrogen atmosphere in order to make sure that no or almost no oxygen enters the infeed section 23. Details of such a feed-system are illustrated in FIG. 4. Instead of nitrogen, also other inert gases (such as Argon) could be used.

“Inside” the infeed section 23, while the material M is being conveyed from the inlet port 22.2 towards the furnace 10, it is “attacked” by the Syngas. The Hydrogen of the Syngas reacts with oxygen residues contained or carried by the material M.

It is also possible to blow the gas from the top onto the material M in the infeed section 23 rather than blowing it into the infeed section 23 from below, as illustrated in FIG. 1.

The feedback pipe 27 may comprise a valve 28 in order to be able to switch the gas feedback on or off. If material M is processed that does not contain oxygen, then the feedback pipe 27 might be switched off by means of the valve 28.

In the furnace 10 exemplified in FIG. 2, the cylinder 1 is held between two annular end plates 2, 3. The structure may be positioned at a slight angle to the horizontal so that the plate 2 can be regarded as an upper end plate and the plate 3 can be regarded as the lower end plate. The cylinder 1 is held in position by two resistant rollers 4, 5, for instance.

Surrounding the cylinder 1 is an induction coil 6 having a length of approximately 2 meters, for instance, and a thickness of approximately 0.015 meters, for instance. The induction coil 6 may be encased in a steel cover 7 so that the system occupies a gas-tight space surrounding the furnace chamber which can be filled with nitrogen or other inert gases.

To assist the continuous movement of material M which is being heat-treated through the furnace chamber 8, a helical protrusion 9 is formed integrating with the internal surface of the cylinder 1. This helical protrusion 9 is optional.

The whole structure is mounted at each end on bearings (not shown in FIG. 2) to provide rotation, and rolling seals and airlocks (also not shown) are also fitted at both ends of the furnace. This ancillary equipment, along with the electrical circuitry of the induction heater and also the heat radiation detector means and related control equipment are all of a conventional nature and therefore need not be described in order to enable the skilled person to operate the new furnace structure of the invention. Only those elements of the ancillary equipment which are relevant for the present invention are described in connection with FIG. 4.

According to a first embodiment of the present invention, oxygen is prevented from entering the inner zone 8 of the furnace 10 by employing a Syngas feedback, as described above.

According to another embodiment of the present invention, a protective coating 12, 13 is applied or coated onto the inner part of the refractory material which is exposed to chemicals and/or oxygen, as schematically illustrated in FIG. 3. FIG. 3 shows a cross-section of an inventive furnace 10. The coating comprises a molybdenum compound 12, respectively a molybdenum-based layer 12 (e.g. a molybdenum alloy), and a Silicon-Boron compound 13, respectively a Silicon-Boron-based layer 13. This stack of two layers 12, 13 is applied or coated onto the inner wall of the furnace 10, since this portion of the wall might be exposed to chemicals and/or oxygen in case the Syngas feedback does not work as intended.

A molybdenum compound combined with a Silicon-Boron (Si-B) compound is very well suited for the purposes of the present invention.

The invention presented herein can be used with all furnaces which create Syngas. The Syngas is generated by the gasification (or high temperature degradation) of a carbon containing material, such as fuel, waste disposal, plants, wood, or residues etc. The Syngas is provided at an output side 30 of the furnace 10. The respective gas output 30 is illustrated in FIG. 4. The details are not addressed herein, since it is common knowledge how to collect gas at the output side 30 of a furnace 10.

In FIG. 4 the whole system 100 is illustrated. The furnace 10 as such is situated inside a box 101. The infeed section 23 is on the right hand side. The output side 30 is on the left hand side of the box 101. The cylinder 1 is indicated by means of a dashed line. The feed-back pipe 27 connects an output gas pipe 102 to the infeed section 23.

The whole system 100 may further comprise a feed-system 200 with a series of containers 201, 202 and conveyors 203, 204, 205 operated with a nitrogen atmosphere in order to make sure that no or almost no oxygen enters the infeed section 23. Details of such a feed-system are illustrated in FIG. 4. The conveyors 203, 204, 205 are preferably arranged at an angle so that the material is moved upwards until it drops into a container 201 or 202. The conveyor 205 moves the material upwards until it drops into the infeed section 23 where a horizontal conveyor 21 (cf. FIG. 1) feeds the material M into the furnace 10. The nitrogen pressure inside the feed-system 200 may be adjusted so that no, or almost no oxygen, enters the infeed section, except for the oxygen that may be contained in the material as such. This oxygen content is being removed by means of the inventive Syngas feedback.

In a preferred embodiment, the hydrogen feedback stream is adjusted depending on the amount of oxygen detected in the infeed section 23. It is advantageous to ensure that there is always more hydrogen than oxygen. An oxygen detector may be installed at the infeed section 23.

In a preferred embodiment, the Syngas at the gas inlet 22.1 has an elevated temperature, preferably a temperature above 100° C. This elevated temperature of the Syngas provides for a pre-heating of the carbon-containing material while passing through said infeed section 23.

It will be understood that many variations could be adopted based on the specific structure hereinbefore described without departing from the scope of the invention as defined in the following claims.

1-14. (canceled)

15. A high-temperature furnace (10) for processing carbon-containing material in an inner zone (8) at a high-temperature, said furnace (10) comprising an infeed side (20) for continuously feeding said carbon-containing material into said inner zone (8) and an output side (30) where a Syngas is provided, characterized in that said infeed side (20) comprises an infeed section (23) providing for an atmosphere being essentially oxygen-free, said infeed section (23) providing for an atmosphere being essentially oxygen-free, said infeed section (23) comprising a gas inlet (22.1) being connectable to said output side (30) for feeding some of said Syngas into said infeed section (23), wherein said Syngas contains carbon monoxide and hydrogen, said hydrogen providing for a chemical reaction with oxygen residues of said carbon-containing material and wherein said furnace (10) comprising a feedback pipe (27) for feeding some of said Syngas back into said infeed section (23).

16. The furnace (10) as claimed in claim 15, comprising a control valve (28) for switching feedback of said Syngas on and off.

17. The furnace (10) as claimed in claim 15, comprising a refractory material coated or protected at its inner side enclosing said inner zone (8) by means of a protective material.

18. The furnace (10) as claimed in claim 17, wherein said protective material comprises a molybdenum compound (12) and a Silicon-Boron (Si-B) compound (13).

19. The furnace (10) as claimed in claim 15, wherein the furnace is cylindrical in shape, the interior surface of the cylinder foaming the lining of a furnace chamber defining said inner zone (8).

20. The furnace (10) as claimed in claim 15, comprising an induction heater (7).

21. Use of a furnace (10) as claimed in claim 15 in the disposal or processing of said carbon-containing material in a continuous fashion.

22. The use of claim 21, wherein said carbon-containing material comprises one or more of the following: waste material, plants, wood, residues.

23. The use of claim 21, wherein an oxygen-free atmosphere is provided in said inner zone (8) and in said infeed section (23).

24. The use of claim 21, wherein temperatures above 800° C. and preferably up to 1700° C. are reached in said inner zone (8).

25. A method for processing carbon-containing material in a high-temperature furnace having an infeed side (20) for feeding said carbon-containing material into an inner zone (8) and an output side (30) where a Syngas is discharged, comprising: providing for an atmosphere essentially oxygen-free in an infeed section (23) of the infeed side (20) while continuously feeding said carbon-containing material into the inner zone (8); providing a gas inlet (22.1) in the infeed section (23) and connecting the gas inlet to said output side (30) by means of a feedback pipe (27); and feeding a portion of the Syngas containing carbon monoxide and hydrogen through the feedback pipe into said infeed section (23), whereby said hydrogen provides for a chemical reaction with oxygen residues of said carbon-containing material section (23).

26. Method of claim 25 wherein said Syngas at the gas inlet (22.1) has an elevated temperature, preferably a temperature at above 100° C., said elevated temperature of the Syngas providing for a pre-heating of said carbon-containing material while passing through said infeed section (23).

27. Method of claim 25 wherein said infeed section (23) is decoupled from the atmosphere by feeding an inter gas into a conveying means (203, 204, 205).

28. Method of claim 25 wherein the hydrogen reacting with the oxygen residues reaches temperatures above 800° C. and preferably up to 1700° C. in the inner zone.
